(19) United States
(12) Patent Application Publication
(10) Pub. No.: US 2015/0116999 A1
(43) Pub. Date: Apr. 30, 2015

(54) MONO-AXIAL LENS FOR MULTIPLE LIGHT SOURCES

(71) Applicant: Avago Technologies General IP (Singapore) Pte. Ltd, Singapore (SG)

(72) Inventors: Kum Soon Wong, Kuala Lumpur (MY); Lig Yi Yong, Penang (MY); Yean Chon Yaw, Penang (MY)

(73) Assignee: Avago Technologies General IP (Singapore) Pte. Ltd, Singapore (SG)

(21) Appl. No.: 14/067,767

(22) Filed: Oct. 30, 2013

(51) Int. Cl. F21V 5/04

(52) U.S. Cl. CPC F21V 5/04
USPC 362/235; 362/335

(57) ABSTRACT

A package for multiple light sources is described. The package includes a plurality of light sources aligned along a first axis and a lens substantially encapsulating the plurality of light source. The lens is designed as a mono-optical lens meaning that a radius of curvature is only created along the first axis of the lens. The lens includes substantially no radius of curvature along a second axis that is perpendicular to the first axis.

### FIELD OF THE DISCLOSURE

The present disclosure is generally directed toward light emitting devices and packages for the same.

### BACKGROUND

Light Emitting Diodes (LEDs) have many advantages over conventional light sources, such as incandescent, halogen, and fluorescent lamps. These advantages include longer operating life, lower power consumption, and smaller size. Consequently, conventional light sources are increasingly being replaced with LEDs in traditional lighting applications. As an example, LEDs are currently being used in flashlights, camera flashes, traffic signal lights, automotive taillights and display devices.

Two prevalent types of LED form factors are surface-mount LEDs and thru-hole LEDs. Surface-mount LEDs are desirable for applications which require a low LED profile. Among the various packages for surface-mount LEDs, an LED package of interest is the Plastic Leaded Chip Carrier (PLCC) package. Surface mount LEDs in PLCC packages may be used, for example, in automotive interior display devices, electronic signs and signals, and electrical equipment.

In both surface-mount LEDs and thru-hole LEDs, lenses have been used to achieve a desired radiation pattern with a controlled viewing angle. To date, the lens profiles have been rounded across both their x-axis and y-axis. These types of lenses have been referred to as dual-axial lenses. Some lens profiles have been constructed to be dual-axis symmetrical (e.g., round shape) or dual-axis non-symmetrical (e.g., oval shape). There are several disadvantages to shaping lenses in such a way.

One problem with dual-axial lenses is that they are centrically aligned with respect to a single point. This means that dual-axial lenses can optimally shape light from a single light source. This also means that any misalignment of the single light source will result in the output light being sub-optimal.

Another problem with dual-axial lenses is that they are relatively difficult to fabricate in a repeatable and optimal manner. As with the misalignment problem described above, because a dual-axial lens is only optimally manufactured for a single point, there is less tolerance to lens fabrication errors. In other words, any lens fabrication errors in either the x-axis or the y-axis will result in a sub-optimal light output.

### BRIEF DESCRIPTION OF THE DRAWINGS

The present disclosure is described in conjunction with the appended figures:

FIG. 1 depicts an isometric view of a mono-axial lens for multiple light sources in accordance with embodiments of the present disclosure;

FIG. 2 depicts a schematic view of a mono-axial lens for multiple light sources in accordance with embodiments of the present disclosure;

FIG. 3A depicts a radiation pattern from a first light source in a mono-axial lens in accordance with embodiments of the present disclosure;

FIG. 3B depicts a radiation pattern from a second light source in a mono-axial lens in accordance with embodiments of the present disclosure;

FIG. 4A depicts an isometric view of a first package in accordance with embodiments of the present disclosure;

FIG. 4B depicts a side view of the package depicted in FIG. 4A;

FIG. 4C depicts an end view of the package depicted in FIG. 4A;

FIG. 5A depicts an isometric view of a second package in accordance with embodiments of the present disclosure;

FIG. 5B depicts a top plan view of the package depicted in FIG. 5A;

FIG. 5C depicts an end view of the package depicted in FIG. 5A;

FIG. 6 depicts a light-emitting display in accordance with embodiments of the present disclosure.

### DETAILED DESCRIPTION

The ensuing description provides embodiments only, and is not intended to limit the scope, applicability, or configuration of the claims. Rather, the ensuing description will provide those skilled in the art with an enabling description for implementing the described embodiments. It being understood that various changes may be made in the function and arrangement of elements without departing from the spirit and scope of the appended claims.

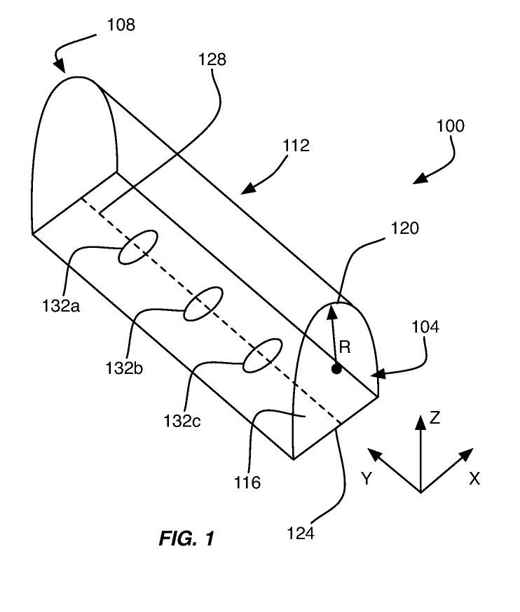

With reference now to FIGS. 1-3B, a mono-axial lens 100 for use in a lighting package comprising a plurality of light sources will be described in accordance with at least some embodiments of the present disclosure. Referring initially to FIG. 1, a mono-axial lens 100 and plurality of light sources 132a, 132b, 132c are shown. In some embodiments, the mono-axial lens 100 may be constructed of any polymer or combination of polymers using extrusion, machining, micro-machining, molding, injection molding, or a combination of such manufacturing techniques. More specifically, the mono-axial lens 100 may be constructed of any transparent or translucent material. Examples of materials that can be used for the lens 100 include, without limitation epoxy, silicone, a hybrid of silicone and epoxy, phosphor, a hybrid of phosphor and silicone, an amorphous polyamide resin or fluorocarbon, glass, plastic, or combinations thereof. In some embodiments, the mono-axial lens 100 may comprise at least one of a solid material, half-solid material, and gel-type encapsulation that substantially encapsulates the light sources 132a, 132b, 132c.

The light sources 132a, 132b, 132c may correspond to any type of known light-emitting device. In some embodiments, the light sources 132a, 132b, 132c may correspond to a Light Emitting Diode (LED), a collection of LEDs, a laser diode, a collection of laser diodes, or any other solid-state light-emitting device. As a non-limiting example, the light sources 132a, 132b, 132c may be configured to emit light of the same characteristics (e.g., color, wavelength, frequency, etc.) or light of different characteristics. For instance, the light sources 132a, 132b, 132c may correspond to red, green, and blue light-emitting LEDs.

The illustrative mono-axial lens 100 comprises a first end 104 and second end 108 with a middle section 112 provided therebetween. The mono-axial lens 100 further includes a single rounded axial plane 116 (e.g., a plane defined between the x-axis and z-axis). The profile of the rounded axial plane 116 is depicted as including a top curved portion 120 and a bottom portion 124. The bottom portion 124 may be substantially flat or planar whereas the curved portion 120 may be rounded (e.g., with a radius of curvature R) substantially within the rounded axial plane 116.

The mono-optical lens 100 is configured to house the light sources 132a, 132b, 132c and create substantially symmetrical radiation patterns for each of the light sources 132a, 132b, 132c. This feature of symmetrically radiating light from each source 132a, 132b, 132c can be achieved by aligning each of the light sources 132a, 132b, 132c along a common axis 128. In some embodiments, the common axis 128 corresponds to a longitudinal axis of the mono-axial lens 100 and the common axis 128 passes directly through the middle of the mono-axial lens 100.

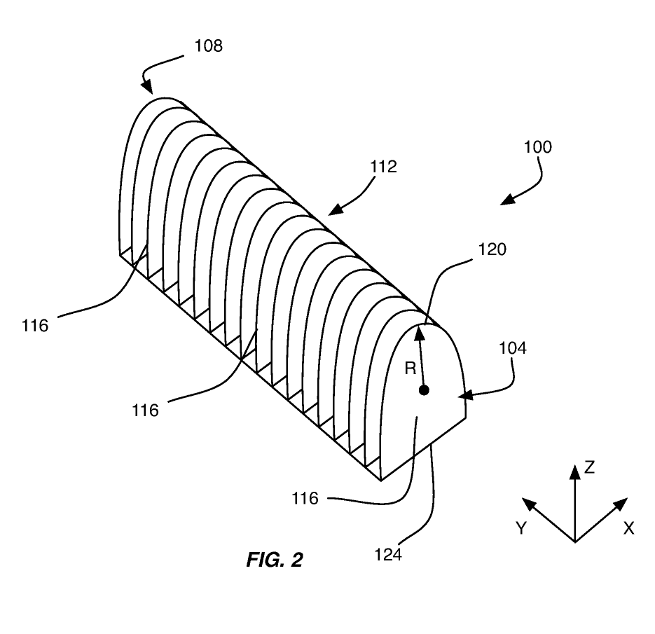

In the coordinate system depicted in FIGS. 1 and 2, the common axis 128 is shown as being substantially parallel to the y-axis, which means that the common axis 128 is substantially perpendicular to the rounded axial plane 116, since the rounded axial plane 116 is shown as being in the x-z plane. It should be appreciated that other cross-sections of the mono-axial lens 100 may also exhibit a radius of curvature; however, these other cross-sections out of the x-z plane would not be perpendicular to the common axis 128. In some embodiments, the mono-axial lens 100 exhibits a cylindrical or tubular-type shape along the common axis 128 rather than exhibiting a spherical or oval shape as is traditionally exhibited by dual-axial lenses of the prior art. Although not depicted, the mono-axial lens 100 may comprise any poly shape including, without limitation, cylindrical shape, valley shape, dual-cylinder shape, dual-valley shape, etc. as the eventual lens shape will depend upon the desired radiation pattern required. Regardless of the shape selected, the mono-axial lens 100 still exhibits only curvature (inward or outward) in a single plane orthogonal to its longitudinal plane and not in its longitudinal plane.

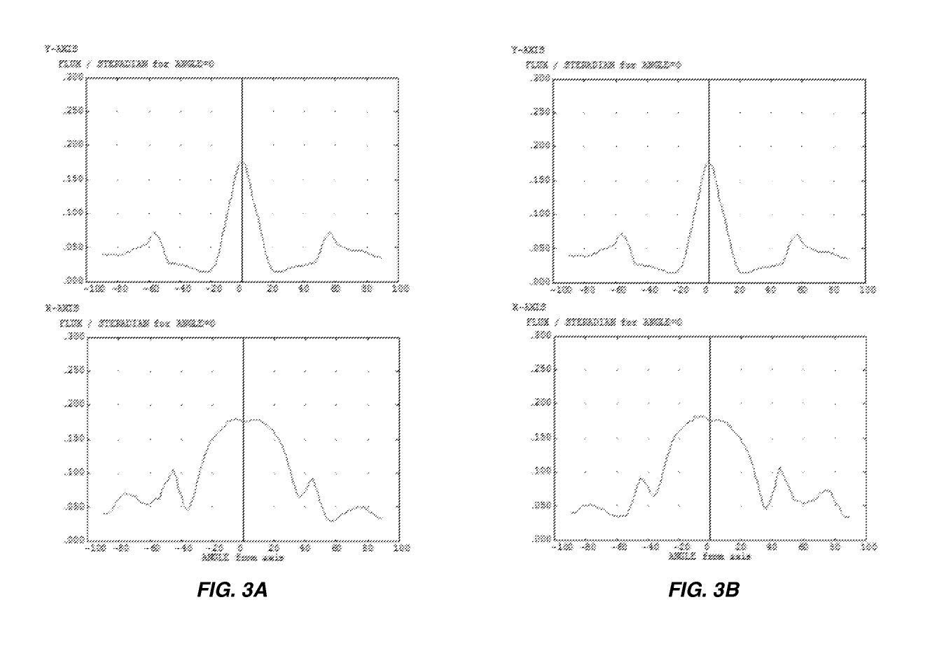

FIG. 2 shows how the mono-axial lens 100 may comprise any number of uniform rounded axial planes 116 along the common axis 128 and along the entire length of the mono-axial lens 100. Each of the rounded axial planes 116 may have a common radius R and each rounded axial plane 116 may comprise a bottom portion 124 and curved portion 120 of equal dimensions. Forming a mono-axial lens 100 in such a way enables the substantially symmetrical radiation of light from each of the light sources 132a, 132b, 132c, even though the light sources 132a, 132b, 132c are not located at the same point. Additional details of the symmetry between radiation patterns from a first light source 132a and a second light source 132b are depicted in the charts of FIGS. 3A and 3B, respectively. Specifically, it can be seen from a comparison of FIG. 3A and 3B that the radiation pattern for each light source is substantially the same in both the x-axis and the y-axis. This means that the light produced by each of the light sources 132a, 132b, 132c is dispersed/radiated by the mono-axial lens 100 in substantially the same way, which helps to produce an even light output from the multiple light sources 132a, 132b, 132c.

In some embodiments, the radius R of the curved portion 120 may be any suitable dimension. Specifically, depending upon the relative size of the mono-axial lens 100 and the light sources 132a, 132b, 132c, the radius R may vary from as small as a micrometer to as large as a meter or more. In other words, the actual size of the radius R can be selected from any suitable size depending upon the desired lighting conditions and radiation pattern.

Furthermore, while FIG. 1 depicts a mono-axial lens 100 substantially encapsulating three light sources 132a, 132b, 132c, it should be appreciated that a mono-axial lens 100 may be constructed to accommodate any number of light sources. More specifically, embodiments of the present disclosure contemplate a mono-axial lens 100 configured to accommodate two, three, four, five, . . . , ten, twenty, or more light sources.

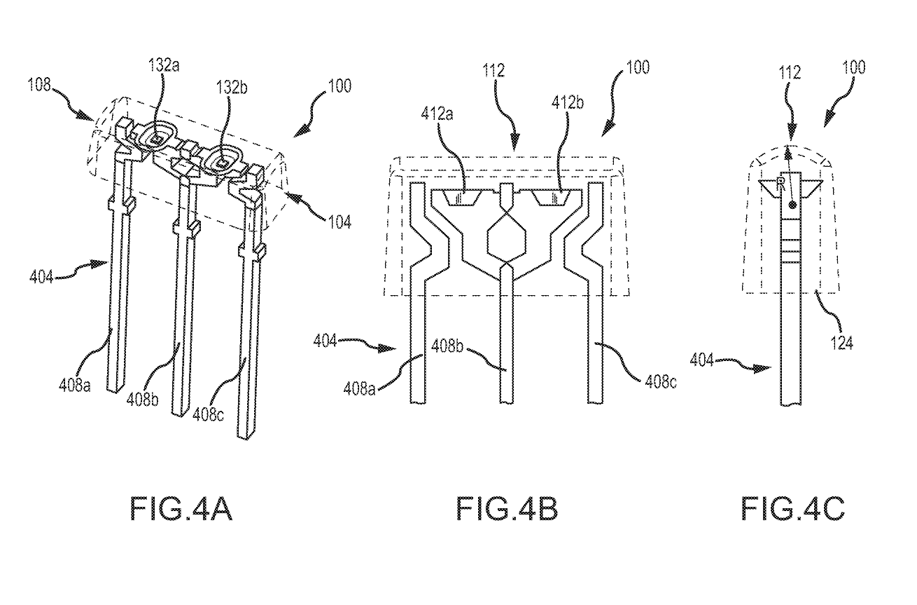

With reference now to FIGS. 4A-C, a first lighting package having a plurality of light sources 132a, 132b will be described in accordance with embodiments of the present disclosure. The lighting package is depicted as having a mono-axial lens 100 as described in connection with FIGS. 1-3B. The package is also depicted as having two light sources 132a, 132b, each being positioned within a reflector cup 412a, 412b. Of course, a greater number of light sources may be used in the first lighting package without departing from the scope of the present disclosure.

In some embodiments, the lighting package includes a leadframe 404 that is substantially configured for thru-hole mounting to a Printed Circuit Board (PCB) or the like. Specifically, the leadframe 404 is constructed from a flat or planar piece of metal and the leadframe 404 is shown to include a plurality of leads 408a, 408b, 408c that extend downwardly from the mono-axial lens 100. In the depicted embodiment, the first lead 408a and third lead 408c are used for a second electrical connection to the light sources 132a, 132b, respectively, whereas the second lead 408b comprises the reflector cups 412a, 412b and supports the light sources 132a, 132b. In some embodiments, the second lead 408b may be configured for connection to an electrical ground or common voltage and the first and third leads 408a, 408c may be used to carry electrical current that dictates whether the light source 132a, 132b is turned on or off. In some embodiments, the material of the mono-axial lens 100 extends below the reflector cups and completely encapsulates the light sources 132a, 132b within the reflector cups.

As can be seen in FIG. 4C, the center of the leadframe 404 and the leads 408a, 408b, 408c are substantially aligned with the common axis 128, thereby enabling each of the light sources 132a, 132b to be mounted along the common axis 128 of the mono-axial lens 100. It should be appreciated that the light sources 132a, 132b do not necessarily need to be mounted in a reflector cup 412a, 412b. It should also be appreciated that a greater or lesser number of leads 408a, 408b, 408c may be provided on the leadframe 404 without departing from the scope of the present disclosure.

FIG. 4B also shows that the extreme ends of the mono-axial lens 100 comprise a small radius along the common axis 128. The location of this minor radius is so far removed from the light sources 132a, 132b, however, that it does not substantially impact the radiation pattern of the light package.

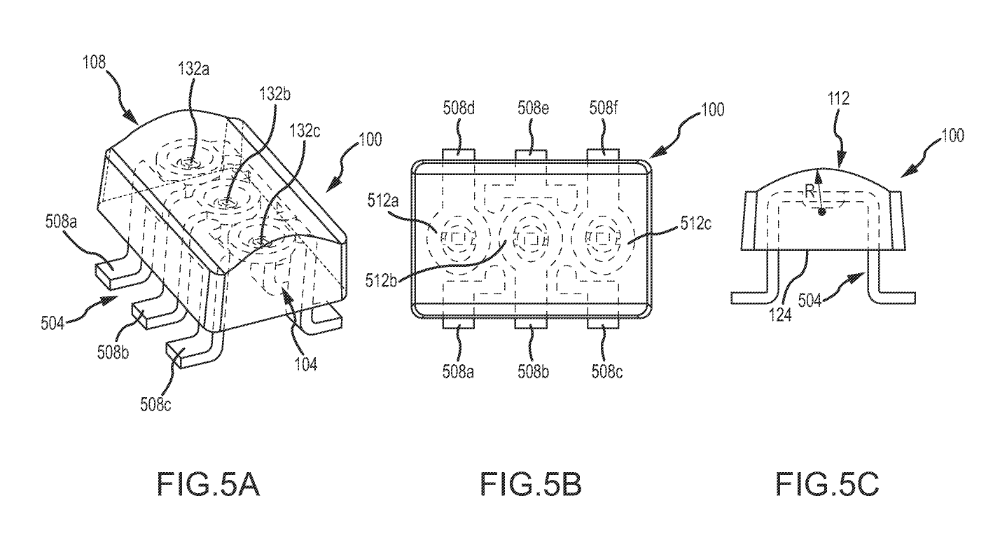

With reference now to FIGS. 5A-C, a second lighting package having a plurality of light sources 132a, 132b, 132c will be described in accordance with embodiments of the present disclosure. The second lighting package is depicted as having a mono-axial lens 100 as described in connection with FIGS. 1-3B. The second lighting package is also depicted as having three light sources 132a, 132b, 132c each being positioned within a reflector cup 512a, 512b, 512c.

The second lighting package comprises a leadframe 504 with a plurality of leads 508a-f configured for surface mounting to a PCB or the like. Although the leads 508a-f are depicted as being configured with an L-bend, it should be appreciated that any type of lead shape may be utilized. Examples of suitable leads shapes include, without limitation, J-wings, C-bends, gullwings, reverse gullwings, etc.

Again, each of the light sources 132a, 132b, 132c are aligned along a common axis 128 that extends through the middle of the mono-axial lens 100. Thus, each reflector cup 512a, 512b, 512c may be centered on the common axis 128, even though the reflector cups 512a, 512b, 512c are attached to different leads 508d, 508b, 508f, respectively. As with the first lighting package, the second lighting package may comprise a mono-axial lens that extends below the reflector cups and encapsulates the reflector cups and light sources. Also as with the first lighting package, a greater or lesser number of light sources may be included in the lighting package without departing from the scope of the present disclosure.

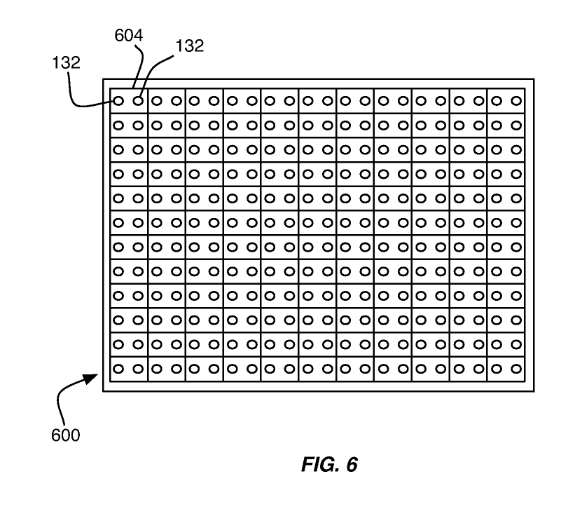

FIG. 6 depicts an example of a display 600 configured to accommodate a plurality of display elements 604 (e.g., pixels) in accordance with embodiments of the present disclosure. Specifically, each display element 604 may correspond to a light source package as depicted and described herein where the light source package includes a plurality of light sources 132 (e.g., two, three, four, five, . . . , ten, twenty, or more) and a mono-axial lens configured to symmetrically shape the light emitted by the plurality of light sources encapsulated therein. The display 600 may correspond to a large billboard or video display that is useable indoors or outdoors. Accordingly, the display 600 may comprise dimensions on the order of hundreds of feet long by hundreds of feet wide and a very large number of display element 604 may be used to create the images presented by the display 600.

Specific details were given in the description to provide a thorough understanding of the embodiments. However, it will be understood by one of ordinary skill in the art that the embodiments may be practiced without these specific details. For example, circuits may be shown in block diagrams in order not to obscure the embodiments in unnecessary detail. In other instances, well-known circuits, processes, algorithms, structures, and techniques may be shown without unnecessary detail in order to avoid obscuring the embodiments.

While illustrative embodiments of the disclosure have been described in detail herein, it is to be understood that the inventive concepts may be otherwise variously embodied and employed, and that the appended claims are intended to be construed to include such variations, except as limited by the prior art.

What is claimed is:

1. A package for a plurality of light sources, the package comprising:
a leadframe having a first lead and a second lead;
a first light source mounted on the first lead;
a second light source mounted on the second lead, wherein the first lead and the second lead are aligned on a common axis; and
a mono-axial lens having a longitudinal axis that coincides with the common axis, wherein the mono-axial lens comprises a radius of curvature in a first plane substantially perpendicular with the common axis and wherein the mono-axial lens comprises substantially no radius of curvature along the longitudinal axis.

2. The package of claim 1, wherein the mono-axial lens comprises at least one of a solid material, half-solid material, and gel-type encapsulation that completely encapsulates the first light source and the second light source.

3. The package of claim 1, wherein the mono-axial lens comprises a poly-shape.

4. The package of claim 1, wherein the mono-axial lens comprises a plurality of rounded axial planes that are substantially parallel with the first plane and wherein each of the plurality of rounded axial planes comprise curved portion shaped according to the radius of curvature.

5. The package of claim 1, further comprising:
a third light source also aligned on the common axis and mounted on a third lead of the leadframe.

6. The package of claim 5, wherein the first light source is mounted in a first reflector cup, wherein the second light source is mounted in a second reflector cup, and wherein the third light source is mounted in a third reflector cup.

7. The package of claim 6, wherein a center of the first reflector cup is substantially aligned with the common axis, wherein a center of the second reflector cup is substantially aligned with the common axis, and wherein a center of the third reflector cup is substantially aligned with the common axis.

8. The package of claim 1, wherein the mono-axial lens is configured to shape light emitted by the first light source and light emitted by the second light source in substantially the same radiation pattern.

9. The package of claim 1, wherein the first lead and second lead are configured for at least one of thru-hole mounting and surface mounting to a Printed Circuit Board (PCB).

10. The package of claim 1, wherein the leadframe is substantially planar and wherein the first and second lead are substantially aligned along the common axis.

11. The package of claim 10, wherein the mono-axial lens comprises at least one of epoxy, silicone, a hybrid of silicone and epoxy, phosphor, a hybrid of phosphor and silicone, an amorphous polyamide resin or fluorocarbon, glass, and plastic.

12. A mono-axial lens for use in a lighting package comprising multiple light sources aligned along a first axis, the lens comprising:
a first end;
a second end;
a middle portion spanning between the first end and the second end; and
a plurality of rounded axial planes that are aligned substantially perpendicular with respect to the first axis, wherein each of the plurality of rounded axial planes comprise curved portions having a radius of curvature, and wherein the middle portion is only curved along the rounded axial planes.

13. The lens of claim 12, wherein the middle portion is at least one of substantially cylindrically shaped and valley shaped.

14. The lens of claim 12, wherein the middle portion is constructed with at least one of epoxy, silicone, a hybrid of silicone and epoxy, phosphor, a hybrid of phosphor and silicone, an amorphous polyamide resin or fluorocarbon, glass, and plastic.

15. The lens of claim 12, wherein the mono-axial lens is configured to shape light emitted by each of the multiple light sources in substantially the same radiation pattern.

16. The lens of claim 12, wherein the middle portion is constructed of at least one of a solid material, half-solid material, and gel-type encapsulation.

17. A light-emitting display, comprising:
a plurality of light source packages configured in an array, wherein each of the plurality of light source packages comprise:
a leadframe having a first lead and a second lead;
a first light source mounted on the first lead;
a second light source mounted on the second lead, wherein the first lead and the second lead are aligned on a common axis; and
a mono-axial lens having a longitudinal axis that coincides with the common axis, wherein the mono-axial lens comprises a cylindrical shape that is substantially aligned with the common axis.

18. The light-emitting display of claim 17, wherein the mono-axial lens comprises at least one of a solid material, half-solid material, and gel-type encapsulation that completely encapsulates the first light source and the second light source.

19. The light-emitting display of claim 17, wherein the first lead and second lead are configured for at least one of thru-hole mounting and surface mounting to a Printed Circuit Board (PCB).

20. The light-emitting display of claim 17, wherein the mono-axial lens is configured to shape light emitted by the first light source and light emitted by the second light source in substantially the same radiation pattern.
